(19) United States
(12) Patent Application Publication
(10) Pub. No.: US 2006/0038700 A1
(43) Pub. Date: Feb. 23, 2006

(54) Sleeve repeater for forwarding meter data

(76) Inventors: Scott Cumeralto, Spokane, WA (US); Richard DeVries, Spokane, WA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/209,344

(22) Filed: Aug. 23, 2005

Related U.S. Application Data
(60) Provisional application No. 60/603,752, filed on Aug. 23, 2004.

(51) Int. Cl. G08C 15/06

(52) U.S. Cl. 340/870.02

(57) ABSTRACT

A sleeve repeater includes a meter sleeve mount and a meter ring mount. The meter sleeve mount interfaces to a utility meter and includes an antenna that is electrically coupled to internal sleeve repeater circuitry. The meter ring mount interfaces with the meter sleeve mount and is attachable to a desired surface to provide a mounted support to the meter sleeve mount and the utility meter. The sleeve repeater includes an antenna that may be internal or external to the meter sleeve mount. An external antenna is preferably enclosed with a dome for protection. The sleeve repeater is able to collect utility meter data from its proximate meter and from a plurality of remotely located repeaters. The sleeve repeater is able to transmit the collected data to collector or other intermediate devices so that the data may reach the head end of an AMR system. A decorative embodiment is available.

### CLAIM TO PRIORITY

The present application claims priority to U.S. Provisional Application No. 60/603,752, filed Aug. 23, 2004, and entitled, “SLEEVE REPEATER AND POLE MOUNTED REPEATER FOR FORWARDING METER DATA.” The identified provisional application is hereby incorporated by reference.

### FIELD OF THE INVENTION

The invention relates generally to radio frequency (RF) communications in fixed network meter reading systems. More particularly, the invention relates to forwarding data transmissions received from encoder/receiver/transmitter (ERT) modules for use with remote meter devices.

### BACKGROUND OF THE INVENTION

Meter reading systems in which a data collection, or reader, device communicates with a plurality of remote meter devices are used by utilities and other companies to improve the efficiency of the meter reading process and reduce the opportunity for erroneous readings. These systems often communicate wirelessly, using radio frequency (RF) signals to collect data and transmit information. A meter reading system can comprise a fixed network, in which a single central reader device or plurality of fixedly mounted and stationary intermediate “frequency hopping” devices communicate with endpoint meter devices. In other configurations, meter reading systems comprise mobile networks, in which vehicle or handheld mobile reader devices move throughout a system's geographic area to communicate with endpoint meter devices.

Endpoint meter devices typically comprise a utility consumption meter, for example a meter that locally monitors electricity, water, or gas consumption, and associated communication circuitry. The communication circuitry can be integrated into the meter but is often a distinct external device communicatively coupled to the meter. Such an external device usually incorporates an independent power supply. Because of space and cost constraints, an autonomous battery supply is often used to power the communication circuitry.

Examples of meter devices and related communications means are described in the following patents. U.S. Pat. No. 5,519,387 is directed to a utility meter assembly and remote module and mounting apparatus and assembly. U.S. Pat. No. 6,067,052 is directed to a loop antenna configuration for printed wire board applications. The antenna can be used with an interface unit that provides a wireless data link with a residential electric utility meter. U.S. Pat. No. 6,262,685 is directed to a passive radiator. The passive radiator is included in an ERT for monitoring the consumption of a metered commodity.

While battery power supplies for communication circuitry as described above take up minimal space, any cost savings may be mitigated by the need to locally service the external device to change out depleted batteries. Therefore, battery consumption saving techniques are implemented in the communication circuitry. Devices can be programmed to “bubble up” at particular times in order to send and receive communications without having to remain powered on to do so during random times. Reducing the power required to transmit communications can also reduce battery consumption. Because this can negatively affect communications capabilities and reduce system read reliability, transmission signal strength must be boosted through other means and methods.

There is, therefore, a need in the industry for a meter reading system and communicative devices that addresses the meter device battery life and transmission signal strength shortcomings associated with conventional meter reading systems and devices while providing accurate and reliable communications capabilities.

### SUMMARY OF THE INVENTION

The invention disclosed herein substantially meets the aforementioned needs of the industry. In particular, a sleeve repeater apparatus for forwarding meter data is disclosed for implementation within automatic meter reading (AMR) systems and provides data collection and relay capabilities that are more efficient, cost-effective, and communicatively robust than prior art solutions.

In one embodiment, the sleeve repeater apparatus comprises a meter sleeve mount adapted to interface with an endpoint meter device. The sleeve repeater apparatus includes an external electrically isolated antenna electrically coupled to interval sleeve repeater circuitry via patch coupling circuitry and ground coupling circuitry. The mount comprises a meter ring mount adapted to mount in a wide variety of meter locations. The meter ring mount is further adapted to receive or retain an antenna dome adapted to enclose and protect the external antenna. In another related embodiment, the repeater apparatus comprises an internal antenna, housed within the meter sleeve mount.

In operation, the repeater apparatus is operable to collect data from nearby ERT modules and to relay the data to an intermediate network collector for subsequent passage to a head-end. The intermediate collector opens communication sessions at regular intervals, listening for data from one or more repeaters, and processes returned data according to default or custom parameters configured at the head-end for each ERT module. In one embodiment, the repeater passes data directly to the head-end.

In another embodiment, the sleeve repeater apparatus of the invention is adapted to operate as a forwarding transceiver. The repeater can collect multiple ERT radio transmissions within geographical and communicative proximity, along with transmissions from other forwarding transceivers, and forward all of the information received to remote transceivers in radio range. In one embodiment, this process continues from one transceiver to the next until the identified collection point for the ERT information is reached. Transceivers will include safeguards to prevent circular re-broadcasting of ERT information and will apply elapsed timing methods to the information to ensure that the most recent ERT data is retained at the final collection point. Circular re-broadcasting protection may include single bit manipulation within the ERT message, total protocol change or frequency changes in band of operation or within the existing band.

The sleeve repeater apparatus of the invention thereby meets the aforementioned needs of the industry and provides numerous advantages over the prior art. The repeater expands the coverage footprint of each intermediate collector to increase the number of ERT modules supported in a given AMR system. The repeater also reduces the total number of intermediate collectors required to achieve optimal system coverage in a network. Further, the repeater contributes to reducing a utility's backhaul communications costs by contributing to the reduction of the number of required intermediate collectors. Embodiments of the sleeve repeater apparatus disclosed and described herein thereby provide a more cost effective fixed network AMR system solution and add desired flexibility for AMR system network layout.

The above summary of the invention is not intended to describe each illustrated embodiment or every implementation of the invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a sleeve repeater apparatus according to one embodiment of the invention.

FIG. 2 is a sleeve repeater apparatus including an external antenna according to one embodiment of the invention.

FIG. 3 is a sleeve repeater apparatus including an external antenna according to one embodiment of the invention.

FIG. 4 is a sleeve repeater apparatus including an external antenna cover according to one embodiment of the invention.

FIG. 5 is a sleeve repeater apparatus including an internal antenna according to one embodiment of the invention.

FIG. 6 is sleeve repeater circuitry including an internal antenna according to one embodiment of the invention.

FIG. 7 is a sleeve repeater apparatus including antenna-coupling circuitry according to one embodiment of the invention.

FIG. 8 is antenna-coupling circuitry according to one embodiment of the invention.

FIG. 9 is repeater circuitry according to one embodiment of the invention.

FIG. 10 is repeater circuitry according to one embodiment of the invention.

FIG. 11 is repeater circuitry according to one embodiment of the invention.

FIG. 12 is repeater circuitry according to one embodiment of the invention.

FIG. 13 is repeater circuitry according to one embodiment of the invention.

FIG. 14 is repeater circuitry according to one embodiment of the invention.

FIG. 15 is repeater circuitry according to one embodiment of the invention.

FIG. 16 is a pole-mount repeater apparatus according to one embodiment of the invention.

FIG. 17 is a pole-mount repeater mounted according to one embodiment of the invention.

FIG. 18 is a decorative embodiment of a pole-mount repeater.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

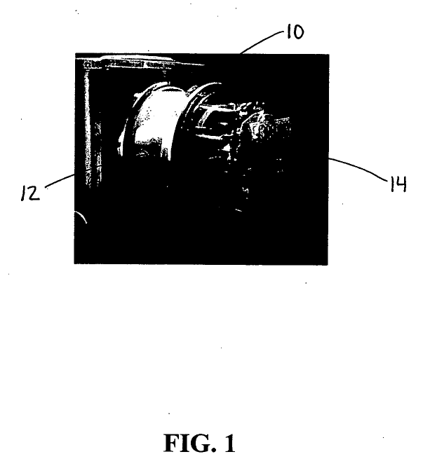

Various embodiments of the sleeve concentrator apparatus of the invention provide a more inexpensive periodic synchronization of meter device endpoints operating within AMR systems while minimizing device battery consumption. The invention can be more readily understood by reference to FIGS. 1-17 and the following description. While the invention is not necessarily limited to such an application, the invention will be better appreciated using a discussion of example embodiments in such a context.

Referring to FIG. 1, a sleeve repeater apparatus 10 according to one embodiment of the invention comprises a meter sleeve mount 12 adapted to interface with an endpoint meter ERT device 14. The endpoint 14 can be an electricity consumption meter or another metering device, for example a water or gas consumption meter. Mount 12 can be installed in virtually any meter location and is compatible with a wide variety of new and existing endpoints 14 such that new systems can be installed and existing systems retrofitted as desired.

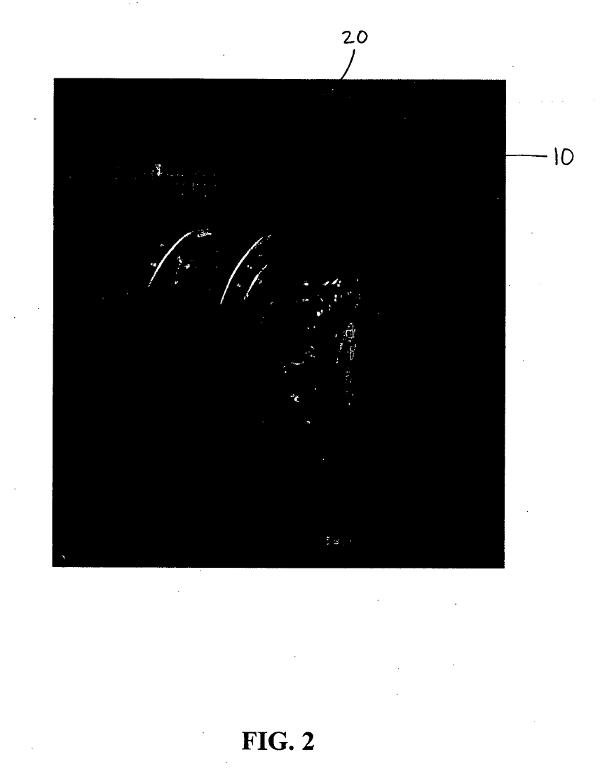

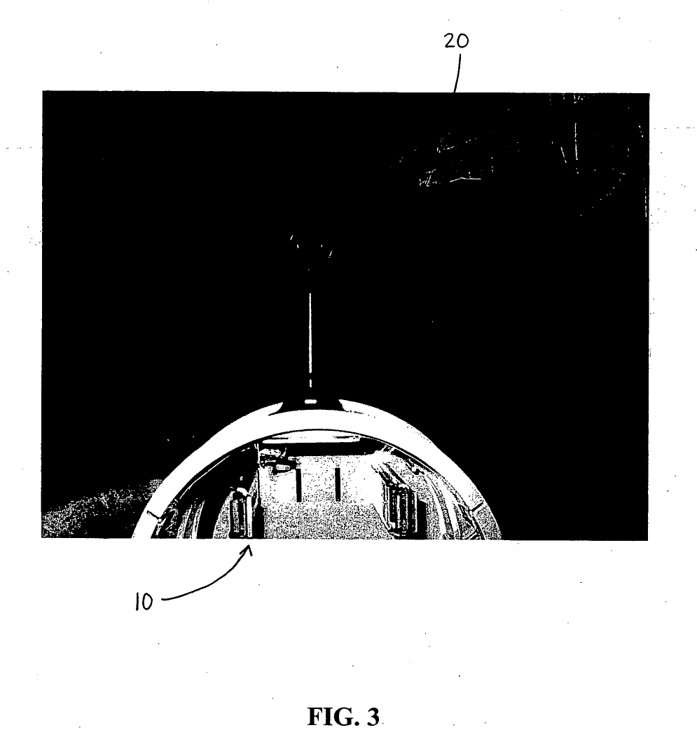

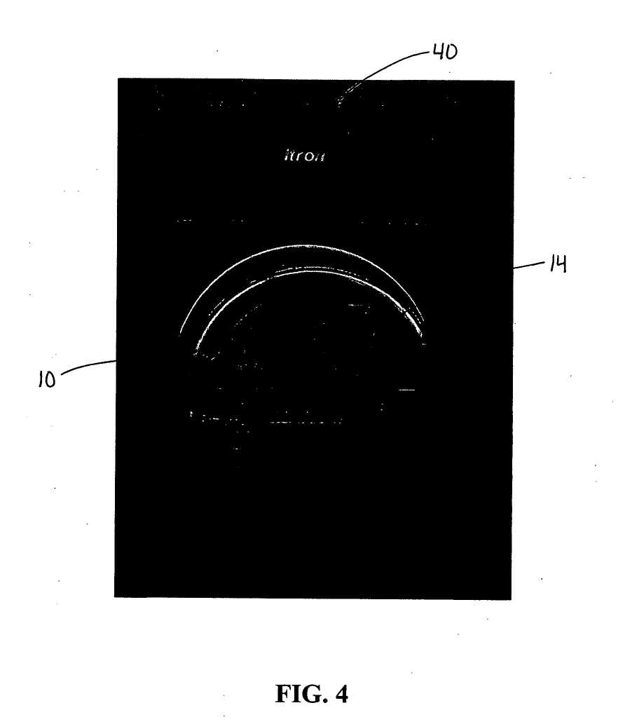

In one embodiment as shown in FIG. 2, the repeater 10 includes an external antenna 20. Another embodiment of external antenna 20 is shown in FIG. 3. External antenna 20 is electrically isolated for safety and can be protected by a dome. One embodiment of a protective dome 40 is shown in FIG. 4.

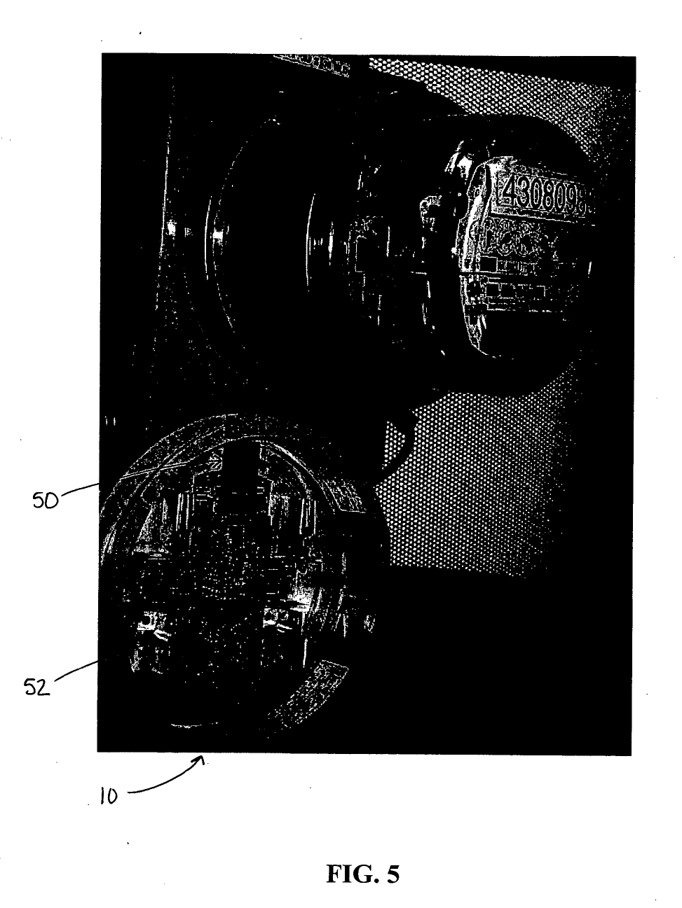

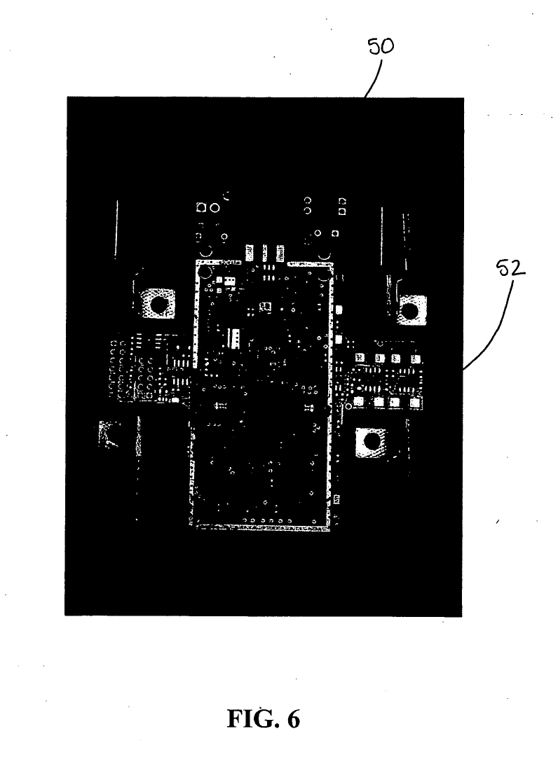

In one alternative embodiment shown in FIG. 5, repeater 10 includes an internal antenna 50. The internal circuitry 52 of repeater 10 associated with this embodiment is shown in FIG. 6. Although external antenna 20 is generally preferred in order to achieve more robust signal transmission and reception capabilities, internal antenna 50 can be used in installations in which clearance or physical space is limited, or wherein external antenna 20 is otherwise not practical or desired.

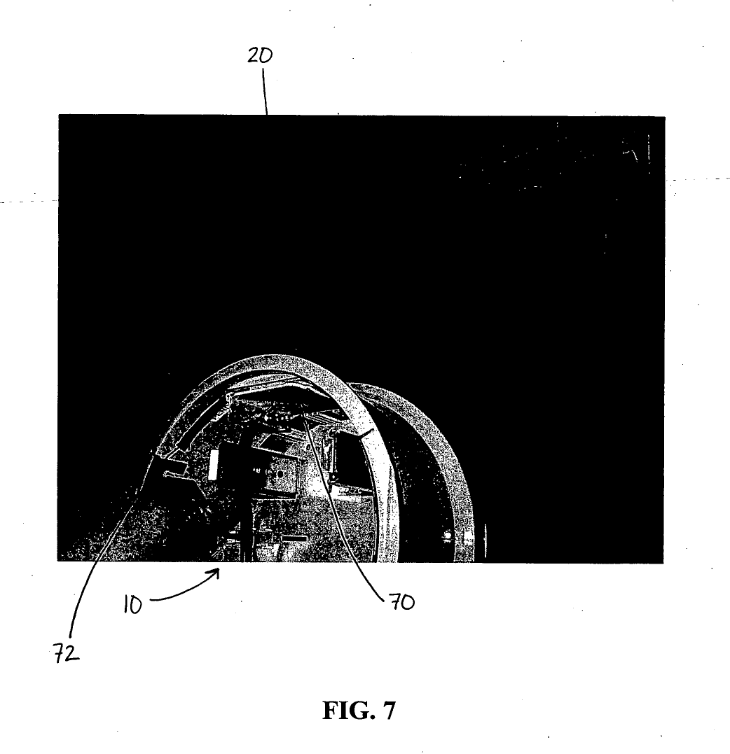

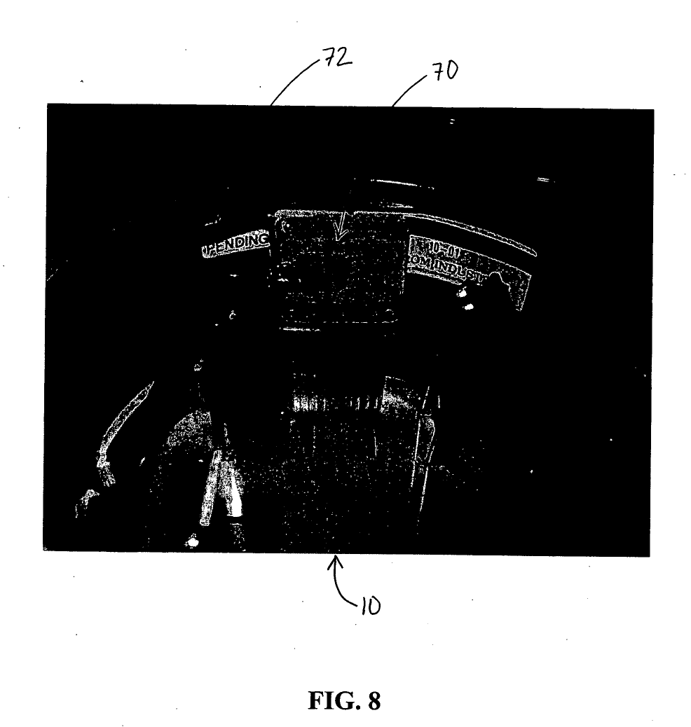

Referring to FIGS. 7 and 8, antenna 20 is capacitively coupled with internal circuitry of repeater 10 via a capacitive patch coupling 70. Patch coupling 70 improves the safety of repeater 10 as it is not directly wired to the transceiver inside the sleeve and is also immune to electrostatic discharge. Independent antenna ground coupling 72 completes the electrical isolation of antenna 20, as coupling 72 is isolated from endpoint 14's ground.

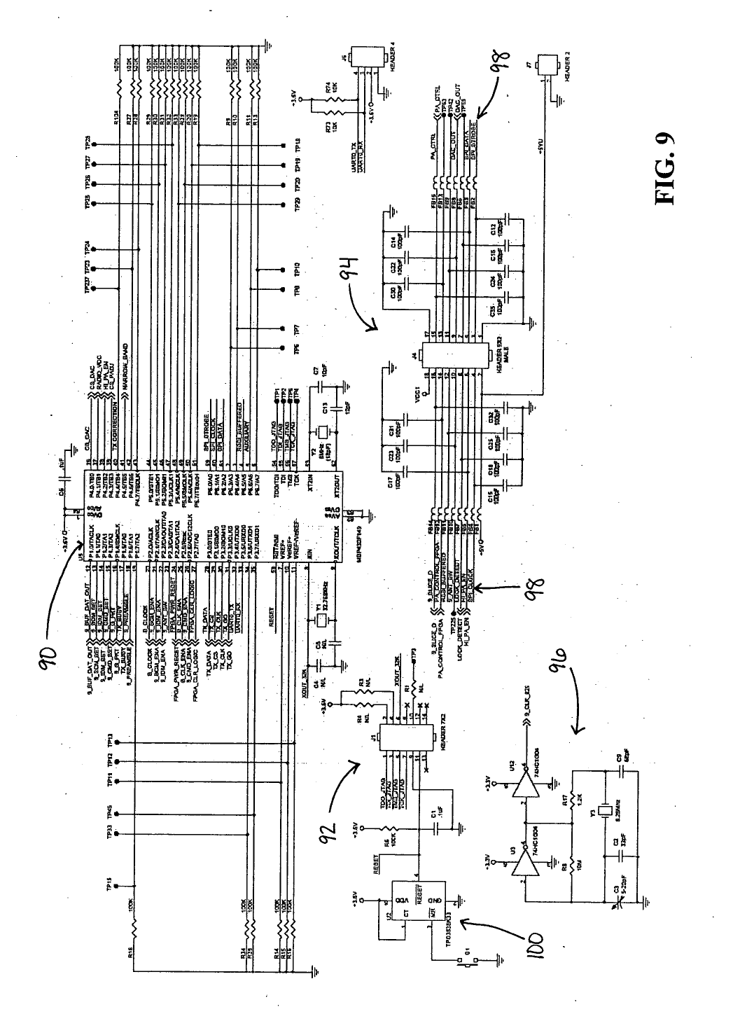

FIGS. 9-15 are circuit schematics of one embodiment of the internal circuitry of repeater 10. Each schematic will be described in more detail below.

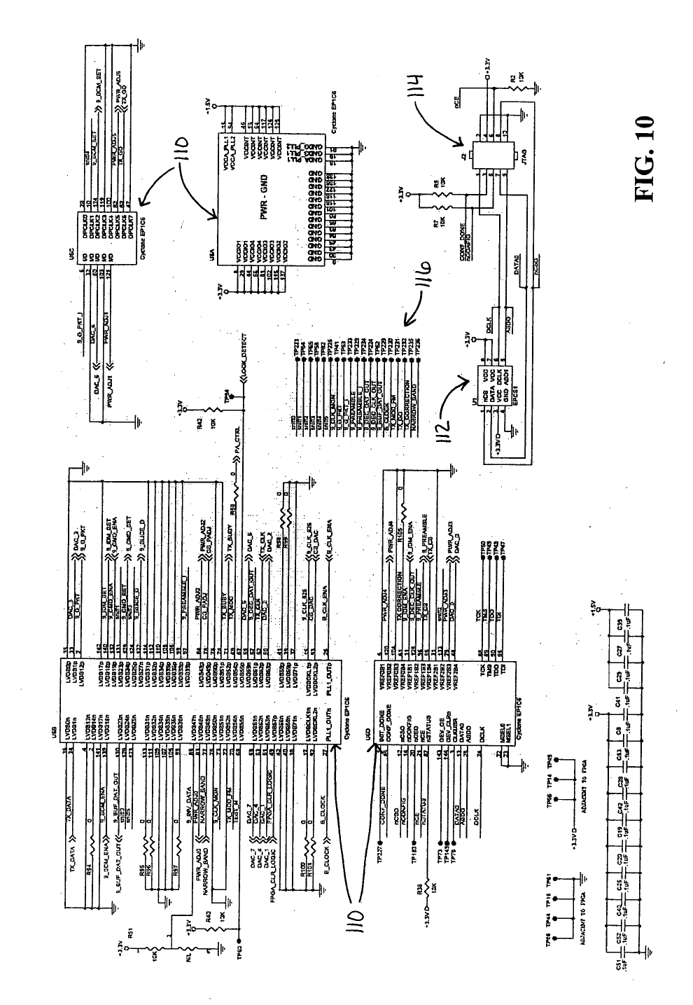

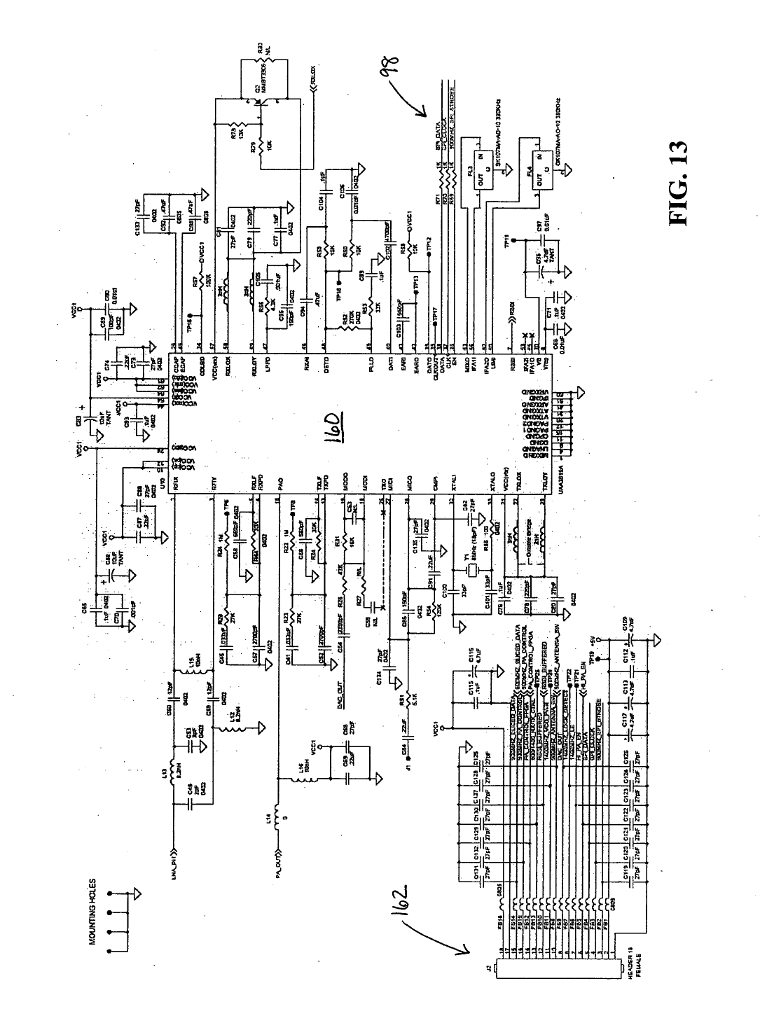

FIG. 9 depicts a repeater microprocessor 90, JTAG programming connection 92, connections 94 to the radio transceiver board (refer to FIG. 13), and a crystal oscillator 96. Microprocessor 90 is an embedded system controller and includes application software in internal FLASH memory. In one embodiment, microprocessor 90 comprises a TEXAS INSTRUMENTS® Microprocessor MSP430F149, although those skilled in the art will recognize that other microprocessors are also compatible. Microprocessor 90 controls the operation of repeater 10 and manages and verifies packet data received by repeater 10 from endpoint 14. Microprocessor 90 also controls the radio transceiver through a serial SPI bus 98. The voltage monitor 100 is operable to reset repeater 10 in the event of a low voltage or brownout condition, thereby providing data protection. In one embodiment, oscillator 96 is an 8.26 MHz crystal oscillator that provides decoder and encoder timing. Oscillator 96 is the master Field Programmable Gate/Logic Array (FPGA) (see FIG. 10) clock. FIG. 10 includes FPGA 110, serial FLASH configuration memory 112, and configuration memory 112 JTAG connection 114. FPGA 110 is depicted in four parts in FIG. 10, although in one embodiment FPGA 110 comprises a single chip. FPGA 110 is placed in the path between microprocessor 90 and the radio transceiver board. FPGA 110 decodes the Manchester-encoded data stream from the radio board for use by microprocessor 90. During receive mode, data is buffered within FPGA 110 for subsequent retrieval by microprocessor 90. During transmission, FPGA 110 receives serial data from microprocessor 90, converts the data to Manchester data, and controls the OOK (On-Off Keying) modulation of the transmitter. Transmit power control is also performed by FPGA 110. Microprocessor 90 communicates with FPGA 110 over a serial SPI bus for data transfers and power settings. FIG. 10 also depicts test points 116.

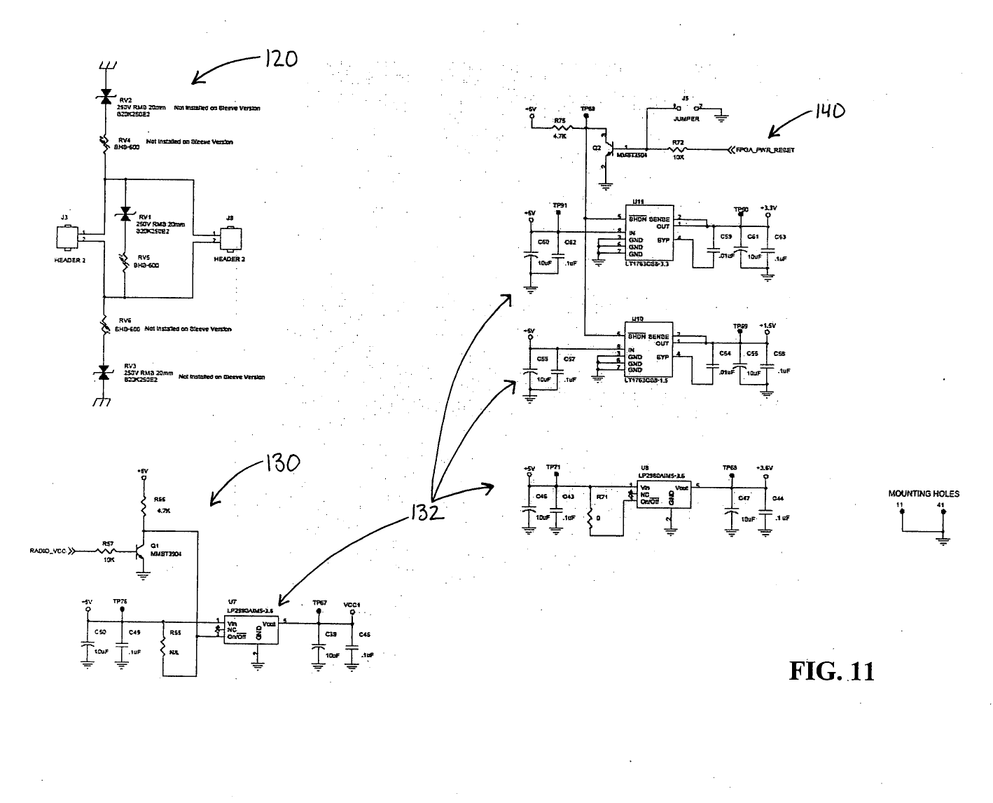

FIG. 11 includes transient voltage protection circuitry 120, low voltage regulators 132, radio board power control (RADIO_VCC) 130, and an FPGA power reset 140. Protection circuitry 120 is placed across the AC line to limit voltage transients at the input to the off-board switching power supply and provide electrostatic discharge protection. Voltage regulators 132 provide multiple voltages for powering the circuitry. Power reset 140 is used by microprocessor 90 to periodically power off FPGA 110 and configuration chip 112 in order to reload a fresh FPGA program copy. Power reset 130 is used by the microprocessor to reset the RF ASIC 160 to periodically reinitialize the transceiver. The internal registers of the RF ASIC are reinitialized after the power reset step.

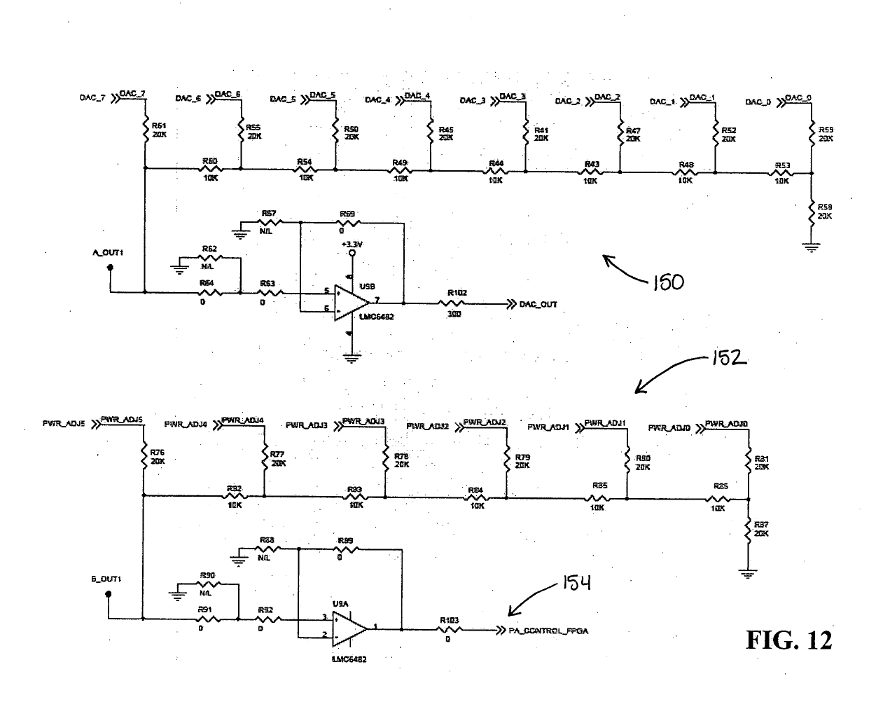

FIG. 12 depicts an eight-bit digital to analog converter (DAC) 150 and a six-bit DAC 152. DAC 150 produces a transmit frequency spreading waveform. Repeater 10 can use a single transmit frequency or can spread a transmission over a frequency range to increase transmit power. In one embodiment, the frequency spreading range is about 500 kHz. DAC 152 includes signal output 154 that is used to adjust transmit power during calibration in order to stay within FCC guidelines.

FIG. 13 shows transceiver 160 and connections 162 to microprocessor 90 via microprocessor connections 94. In one embodiment, transceiver 160 comprises a PHILIPS® UAA3515A RF application specific integrated circuit (ASIC), although those skilled in the art will recognize that other transceiver chips can also be used without departing from the spirit and scope of the invention disclosed and described herein. Transceiver 160 is operable to set transmit and receive frequencies, as the endpoints 14 “hop” frequencies. Transceiver 160 communicates with microprocessor 90 over serial SPI bus 98 and responds to set up and frequency control information from microprocessor 90.

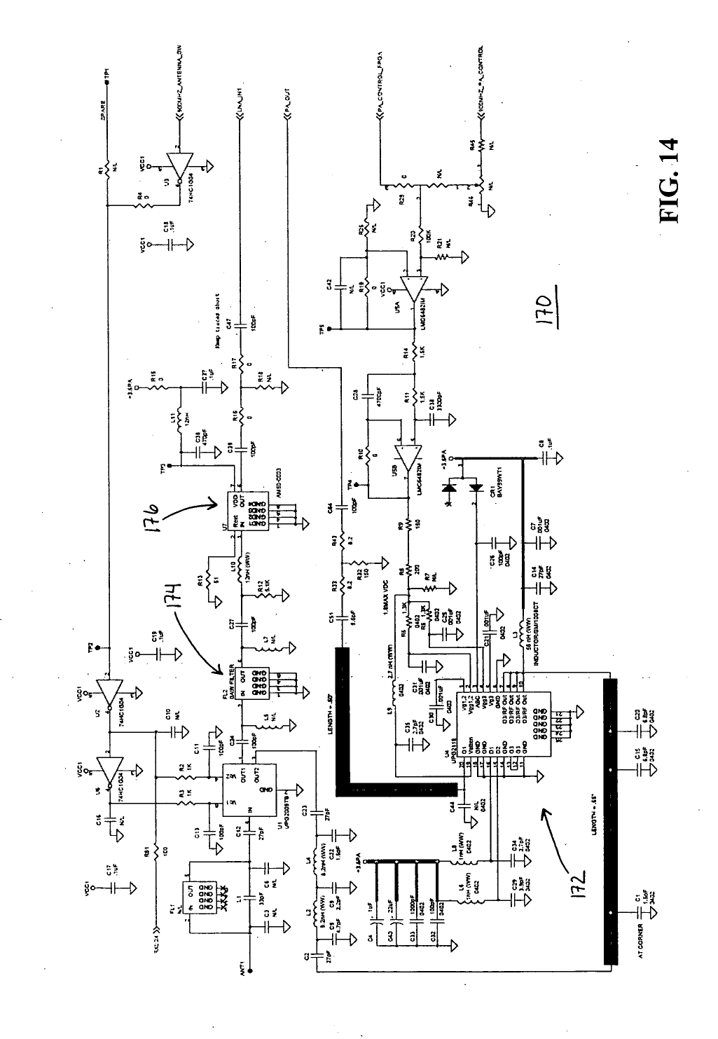

FIG. 14 includes circuitry 170 between transceiver 160 and antenna 20. Circuitry 170 includes a power amplifier 172, SAW filter 174, low noise amplifier (LNA) 176, as well as discrete filtering circuitry. An antenna switch selects either receive or transmit mode. When operating in transmit mode, power amplifier 172 boosts the transmit signal destined for antenna 20. When operating in receive mode SAW 174 and the discrete filtering components reject unwanted signals before arriving at the LNA 176. LNA 176 increases the signal level for use by the transceiver 160. SAW 174 and the discrete filtering components reject out-of-band, undesired signals before arriving at transceiver 160.

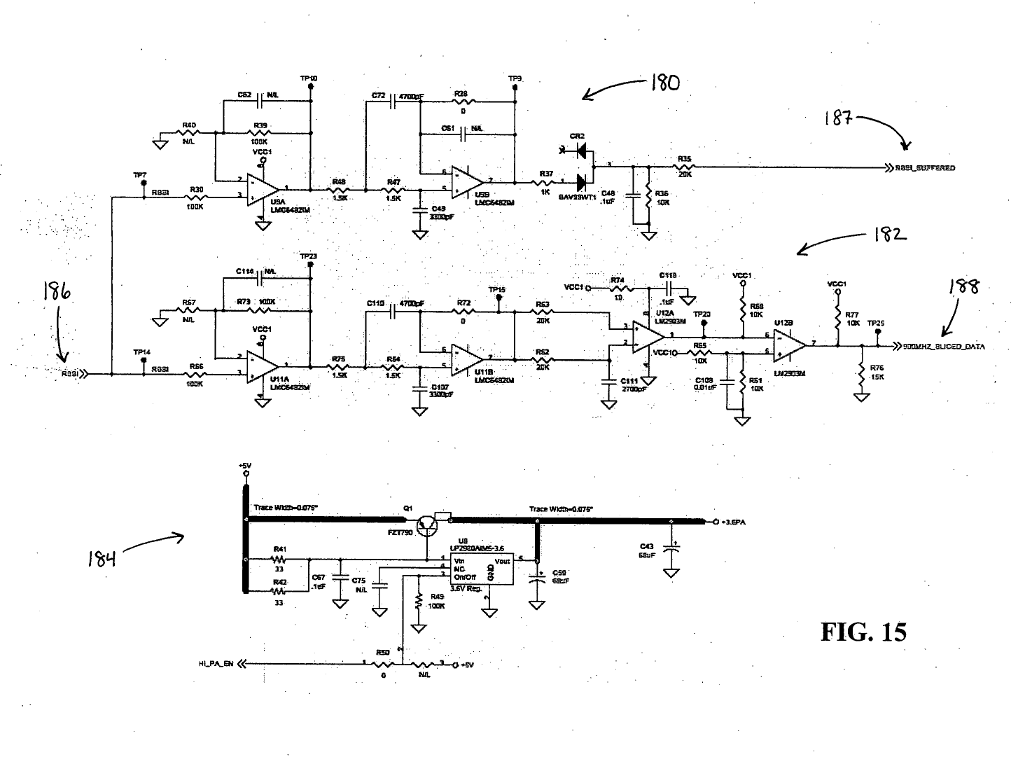

FIG. 15 includes RSSI signal buffering 180, a data slicer 182, and a voltage regulator 184 for power amplifier 172. RSSI signal 186 is provided by the receiver and follows the received data stream. After buffering, signal 187 is recovered audio used to evaluate radio performance. Data slicer 182 converts signal 186 to logic level data 188 for further processing by FPGA 110 and microprocessor 90. In particular, RSSI signal 186 is converted to a logic square wave as a data source to FPGA 110. This is recovered Manchester-formatted data without encoding and FPGA 110 separates the data to a clock and data line to feed to microprocessor 90. Additional voltage regulator 184 ensures that adequate power is available to power amplifier 172 during transmit.

In operation, repeater 10 functions as an AMR system network component that collects data from nearby ERT endpoint modules 14 and from other repeaters 10 and passes data to either a collector that in turn communicates the data to the head-end in one embodiment, or directly to the head-end in another embodiment. Collectors open communication sessions at regular intervals to listen for data from repeater 10. Repeater 10 thereby expands radio coverage and increases the area covered by a single collector. Repeaters further reduce AMR system cost by reducing the number of comparatively more expensive collectors required to achieve desired radio communication coverage. This also increases system flexibility with regard to fixed network solutions and network layout.

In a related embodiment, repeater 10 can be configured to operate as a concentrator so as to provide data storage and data management capability where needed in the system in place of one of the sleeve repeaters described above and so as to periodically test its surroundings for data packets transmitted by endpoint 14. In one embodiment, Repeater 10 is always on but will periodically reset and reload. Repeater 10 also volunteers statistical information, for example how many packets have been received in a given period of time, device local temperature, power levels of transmission to the head-end. Repeater 10 identifies valid data packets by a preamble. In one embodiment, data packets are fixed length, or alternatively variable length, and repeater 10 and ERT endpoint 14 communicate in the 900 MHz radio band or alternatively as a frequency translator to 1.4 GHz or other appropriate radio frequencies. After receiving a data packet, repeater 10 acts based upon the packet. For example, repeater 10 validates and confirms the data and then resends the data with a spare bit set such that a subsequent repeater 10 can differentiate original messages from repeated messages. A system of endpoints 14 thereby transmits data to repeaters 10, which in turn relay data to other repeaters 10 and eventually the head-end.

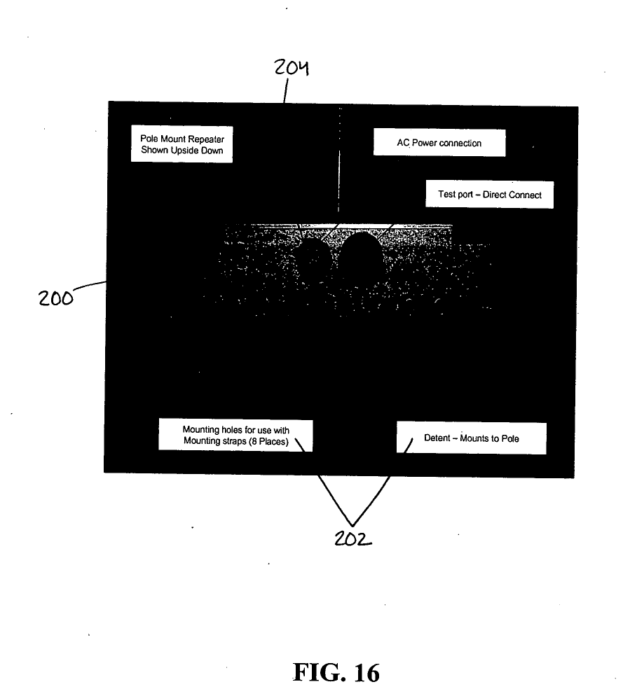

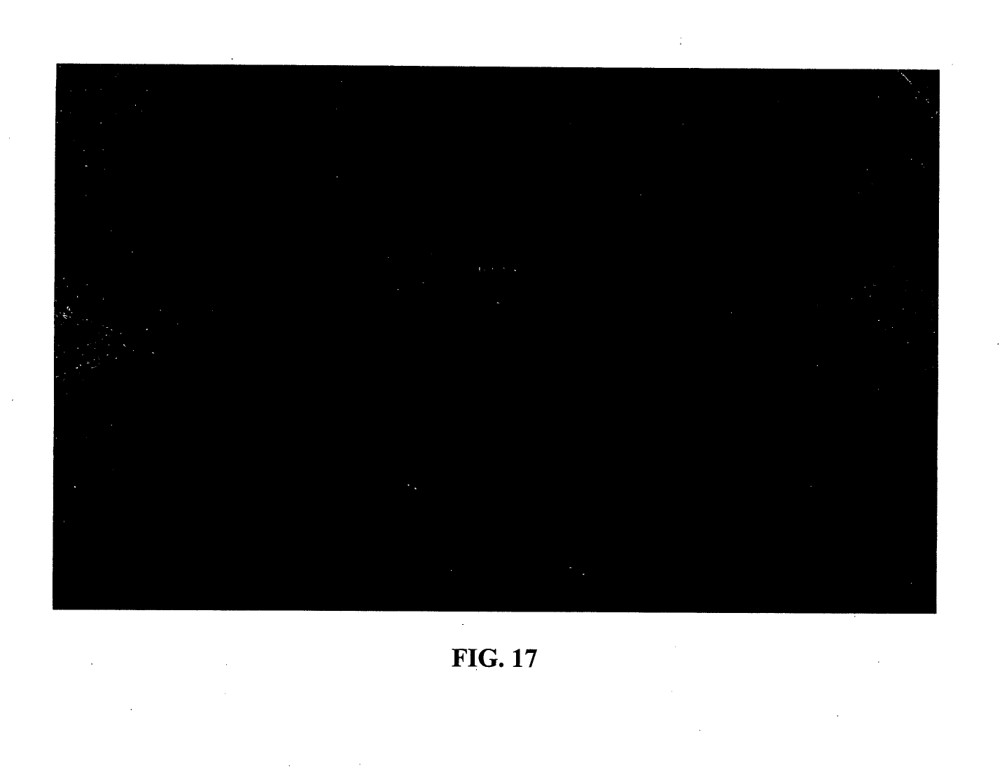

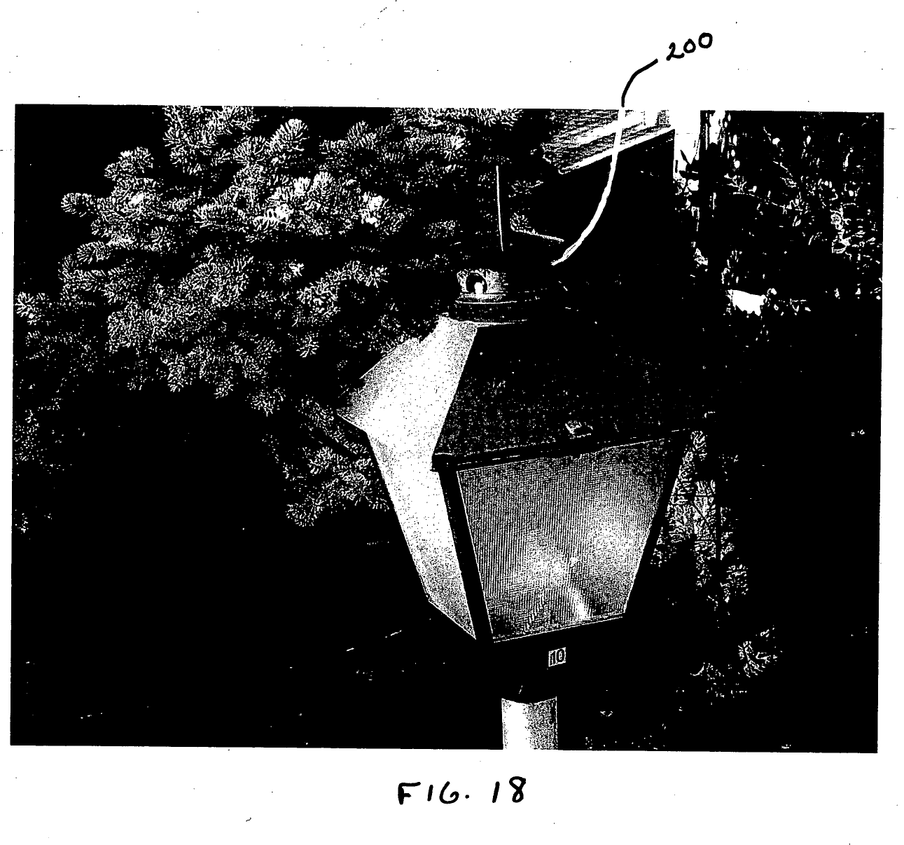

In one embodiment, an AMR system can include intermediate pole mount repeaters rather than sleeve repeaters as described above with reference to FIG. 1. FIG. 16 is one embodiment of a pole mount repeater 200, which can collect data from endpoint ERTs 14 and transmit data to a head-end. Pole mount repeater 200 includes mounting means 202 for mounting to a pole or other structure and an AC power connection 204. FIG. 17 shows pole mount repeater 200 mounted to a light pole. FIG. 18 depicts still another embodiment of the pole-mount repeater 200, wherein the pole-mount repeater 200 is provided in a decorative configuration to blend in with ornamental streetlights, such as those found in home neighborhoods. The decorative pole-mount repeater 200 is also preferably colored to blend in with the coloration of the decorative streetlight itself, e.g., black. In a further embodiment, the pole-mount repeater is equipped as a multi-channel repeater that is capable of listening to a plurality of radio signals, e.g., 8, 16, or more, simultaneously rather than one at a time.

The invention may be embodied in other specific forms without departing from the essential attributes thereof; therefore, the illustrated embodiments should be considered in all respects as illustrative and not restrictive. The claims provided herein are to ensure adequacy of the present application for establishing foreign priority and for no other purpose.

What is claimed:

1. A sleeve repeater apparatus, comprising:
a meter sleeve mount, wherein said meter sleeve mount interfaces to a utility meter and wherein said meter sleeve mount includes an antenna that is electrically coupled to internal sleeve repeater circuitry; and
a meter ring mount, wherein said meter ring mount interfaces with said meter sleeve mount and is attachable to a desired surface to provide a mounted support to said meter sleeve mount and said utility meter.

2. The sleeve repeater apparatus of claim 1, wherein said antenna comprises an antenna external to said meter sleeve mount.

3. The sleeve repeater apparatus of claim 2, wherein said apparatus further comprises an antenna dome, wherein said antenna dome encloses the external antenna.

4. The sleeve repeater apparatus of claim 1, wherein said antenna comprises an antenna internal antenna housed within said meter sleeve mount.

5. The sleeve repeater apparatus of claim 1, wherein said internal sleeve repeater circuitry includes circuitry for collecting and transmitting utility meter data.

6. The sleeve repeater apparatus of claim 5, wherein said utility meter data is generated by a utility meter that is remote from said sleeve repeater apparatus.

7. The sleeve repeater apparatus of claim 5, wherein said utility meter data is generated by a plurality of utility meters that are remote from said sleeve repeater apparatus.

8. An automatic meter reading system, comprising:
a utility meter;
a sleeve repeater, operatively interfaced to said utility meter, wherein said sleeve repeater transmits data generated by said utility meter; and
a collector, wherein said collector receives the data transmitted by said sleeve repeater.

9. The system of claim 8, wherein said sleeve repeater comprises a meter sleeve mount than includes an antenna that is electrically coupled to internal sleeve repeater circuitry, and a meter ring mount, wherein said meter ring mount interfaces with said meter sleeve mount and is attachable to a desired surface to provide a mounted support to said meter sleeve mount and said utility meter.

10. The system of claim 9, wherein said sleeve repeater further comprises an antenna external to said meter sleeve mount.

11. The system of claim 10, wherein said sleeve repeater further comprises an antenna dome, wherein the antenna dome encloses the external antenna.

12. The system of claim 8, wherein said antenna comprises an internal antenna housed within said meter sleeve mount.

13. The system of claim 8, wherein said sleeve repeater additionally collects data from a plurality of utility meters located remotely from said sleeve repeater.

14. The system of claim 13, wherein said sleeve repeater transmits the collected data from said plurality of utility meters to said collector.

15. A method for collecting meter data in an automatic meter reading (AMR) system, wherein said AMR system includes a utility meter, a sleeve repeater, and a collector, the method comprising:
generating utility data with said utility meter;
collecting said utility data with said sleeve repeater; and
transmitting from said sleeve repeater to said collector the collected data.

16. The method of claim 15, further comprising the step of collecting additional utility data from a plurality of utility meters with said sleeve repeater, wherein said plurality of utility meters are remotely located from said sleeve repeater.

17. The method of claim 16, further comprising the step of transmitting the utility data from said plurality of utility meters to one or more collectors.

18. The method of claim 15, wherein said sleeve repeater comprises a meter sleeve mount than includes an antenna that is electrically coupled to internal sleeve repeater circuitry, and a meter ring mount, wherein said meter ring mount interfaces with said meter sleeve mount and is attachable to a desired surface to provide a mounted support to said meter sleeve mount and said utility meter.

19. The method of claim 18, wherein said sleeve repeater further comprises an antenna external to said meter sleeve mount.

20. The method of claim 18, wherein said antenna comprises an internal antenna housed within said meter sleeve mount.
